(19) United States
(12) Patent Application Publication
(10) Pub. No.: US 2002/0176256 A1
(43) Pub. Date: Nov. 28, 2002

(54) Lighting fixture

(76) Inventor: Damien Gires, Paris (FR)

Correspondence Address: BACON & THOMAS, PLLC, 625 SLATERS LANE, FOURTH FLOOR, ALEXANDRIA, VA, 22314

(21) Appl. No.: 09/863,327

(22) Filed: May 24, 2001

(51) Int. Cl. F21V 11/00

(52) U.S. Cl. 362/351

(57) ABSTRACT

A lighting fixture for indoor illumination, having a base, an upright support fixedly mounted on the base to hold a lamp holder and lamp bulbs in the lamp holder, a light-permeable lampshade fixedly fastened to the periphery of the lamp holder and surrounding the lamp bulbs, and a light-permeable elastic color shade detachably sleeved onto the lampshade to filter the color of light of the lamp bulbs passing through the lampshade.

### BACKGROUND OF THE INVENTION

The present invention relates to a lighting fixture for indoor illumination and, more particularly, to such a lighting fixture that allows the user to change the design of the lampshade conveniently.

Regular lighting fixtures are commonly provided with a lampshade placed round the lamp bulb. Because the shade of the lampshade is not detachable, the design of the lampshade is not changeable. If the user wishes to change the design of the lampshade, the whole lampshade must be replaced, i.e., the user must prepare several lampshades for selection. It is not economic to prepare several lampshades for use with a lighting fixture. Further, it is complicated to install or dismount the lampshade.

### SUMMARY OF THE INVENTION

The present invention has been accomplished under the circumstances in view. It is the main object of the present invention to provide a lighting fixture, which allows the user to change the replace the shade of the lampshade conveniently. According to one aspect of the present invention, the lighting fixture comprises a base, an upright support mounted on the base to hold a lamp holder and lamp bulbs in the lamp holder, a lampshade fastened to the lamp holder round the lamp bulbs, and a light-permeable elastic color shade detachably sleeved onto the lampshade to filter the color of light of the lamp bulbs passing through the lampshade. According to another aspect of the present invention, the shade can be rolled up to let a part of the lampshade be exposed to the outside.

### BRIEF DESCRIPTION OF THE DRAWINGS

FIG. 1 is a sectional view of a lighting fixture according to the present invention.

FIG. 2 is a perspective view of the lighting fixture according to the present invention.

### DETAILED DESCRIPTION OF THE PREFERRED EMBODIMENT

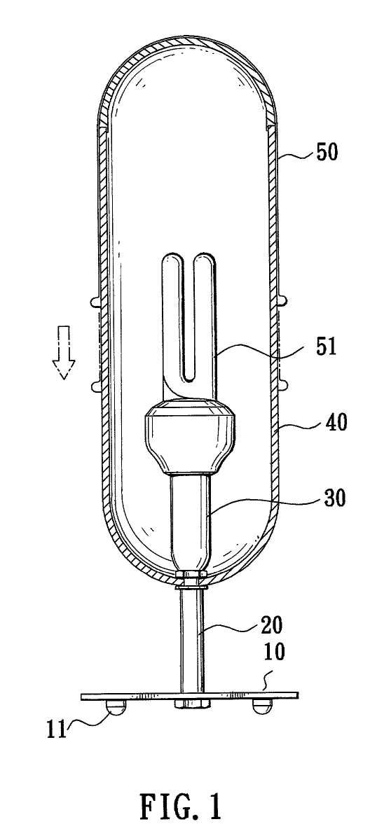

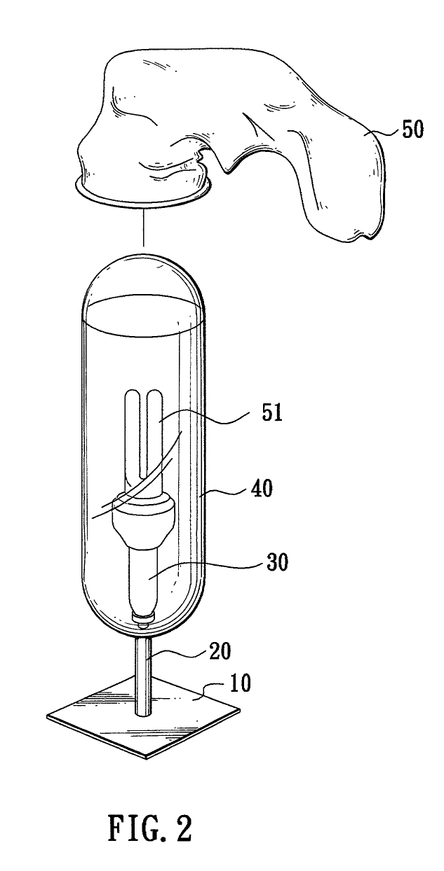

Referring to FIGS. 1 and 2, a lighting fixture in accordance with the present invention is designed for indoor illumination. The lighting fixture comprises a base 10, a plurality of foot members 11 provided at the bottom side of the base 10, an upright support 20 vertically fastened to the base 10 at the top side, a lamp holder 30 mounted on the top side of the upright support 20 to hold lamp bulbs 31. According to the preferred embodiment of the present invention, the base 10 is a rectangular plate. The upright support 20 is a hollow screw rod fastened to the base 10 by a lock nut. The power cord of the lamp holder 30 is inserted through the upright support 20 for connection to power source. Further, a lampshade 40 is fastened to the periphery of the lamp holder 30 and disposed around the lamp holder 30 and the lamp bulbs 31, and a color shade 50 is sleeved onto the lampshade 40. According to the preferred embodiment of the present invention, the lampshade 40 is made of light-permeable material, having an oval shape. The color shade 50 is made from elastic plastic material that admits light.

Referring to FIGS. 1 and 2 again, the shade 50 can be covered over the whole area of the lampshade 40. Alternatively, the bottom side of the shade 50 can be rolled up to let the lower part of the lampshade 40 be exposed to the outside, for enabling a part of the light of the lamp bulbs 31 to pass through the lampshade 40 and the shade 50 and the other part of the light of the lamp bulbs 31 to pass to the lampshade 40 without through the shade 50. Because the shade 50 is directly sleeved onto the lampshade 40, it is replaceable, i.e., different colors of shade can be alternatively used and covered on the lampshade 40.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A lighting fixture comprising:
a base;
an upright support fixedly mounted on said base at a top side, said upright support holding a lamp holder at a top side thereof and at least one lamp bulb in said lamp holder;
a light-permeable lampshade fixedly fastened to the periphery of said lamp holder and surrounding said lamp holder and said at least one lamp bulb; and
a light-permeable elastic shade sleeved onto said lampshade.

2. The lighting fixture of claim 1 wherein said light-permeable elastic shade has a color design.
